(19) United States
(12) Patent Application Publication
(10) Pub. No.: US 2024/0164005 A1
(43) Pub. Date: May 16, 2024

(54) INDUCTION DEVICES FOR INDUCTIVELY COUPLED PLASMA TORCHES AND METHODS AND SYSTEMS INCLUDING SAME

(71) Applicant: PERKINELMER U.S. LLC, Shelton, CT (US)

(72) Inventors: Peter Morrisroe, New Milford, CT (US); Cindy Anderau, Sandy Hook, CT (US); Michael Pawlyk, Ansonia, CT (US)

(21) Appl. No.: 18/055,882

(22) Filed: Nov. 16, 2022

(51) Int. Cl. H05H 1/30; H01F 38/14

(52) U.S. Cl. CPC H05H 1/30; H01F 38/14

(57) ABSTRACT

An induction device includes a helical structure including a first aperture, and a non-helical structure including a second aperture. The first and second apertures define a passageway that is configured to receive a portion of a body of an inductively coupled plasma (ICP) torch.

### FIELD

The present technology relates to plasma sources and, more particularly, to inductively coupled plasma torches and induction devices used therewith.

### BACKGROUND

Some inductively coupled plasma (ICP) devices use an ICP torch including an induction device to generate plasma. It is desirable to design the induction device such that robust plasma is generated that can ionize challenging samples without extinguishing.

### SUMMARY

Some embodiments of the present technology are directed to an induction device including a helical structure including a first aperture, and a non-helical structure including a second aperture. The first and second apertures define a passageway that is configured to receive a portion of a body of an inductively coupled plasma (ICP) torch, and the passageway defines a longitudinal axis.

In some embodiments, the helical structure includes a helical plate and the non-helical structure includes a flat plate.

In some embodiments, the helical plate includes a primary body including the first aperture and first and second legs extending away from the primary body. In some embodiments, the flat plate includes a primary body including the second aperture and first and second legs extending away from the primary body.

In some embodiments, the first leg of the helical plate and the flat plate are spaced apart axially a first distance, and the second leg of the helical plate and the flat plate are spaced apart axially a second distance. The second distance may be greater than the first distance. The first distance may be the smallest gap between the helical plate and the flat plate and the second distance may be the largest gap between the helical plate and the flat plate. The first distance may be 2 to 3 mm and/or the second distance may be 5 to 6 mm.

In some embodiments, the first leg of the helical plate is axially aligned with the second leg of the flat plate, and the second leg of the helical plate is laterally offset from the flat plate relative to the longitudinal axis.

In some embodiments, the second leg of the helical plate and the first leg of the flat plate are each configured to be supplied with radio-frequency electric current, and the first leg of the helical plate and the second leg of the flat plate are configured to be connected to ground.

In some embodiments, the induction device further includes a spacer between the first leg of the helical plate and the second leg of the flat plate. The spacer may contact each of the first leg of the helical plate and the second leg of the flat plate.

In some embodiments, the induction device further includes an electrode connected to each of the second leg of the helical plate, the first leg of the flat plate, and the second leg of the flat plate.

In some embodiments, the induction device further includes a conductive plate to which the helical plate and flat plate are coupled. The electrodes and/or the conductive plate may be configured as a heat sink to promote cooling of the helical plate and flat plate.

In some embodiments, the primary body of the helical plate is in the shape of a loop and makes substantially a single rotation or turn between the first leg and the second leg of the helical plate.

In some embodiments, the helical plate and the flat plate each have a thickness of about 2 mm.

In some embodiments, the helical plate has a pitch of 4 to 6 mm per rotation.

In some embodiments, the helical structure comprises a coil. The coil may be a single coil.

In some embodiments, the helical structure and/or the non-helical structure are formed of aluminum.

In some embodiments, the helical structure and/or the non-helical structure are formed of copper.

Some other embodiments of the present technology are directed to an inductively coupled plasma (ICP) torch including: an injector configured to receive a flow of a sample fluid; a plurality of tubes disposed about the injector and configured to receive and direct a flow of one or more torch gases; and an induction device disposed about at least one of the plurality of tubes, the induction device configured to receive a radio-frequency electric current to inductively energize at least one of the one or more torch gases to produce a plasma proximate a distal end of the ICP torch. The induction device includes a helical structure including a first aperture, and a non-helical structure including a second aperture. The first and second apertures define a passageway that is configured to receive the at least one of the plurality of tubes, and the passageway defines a longitudinal axis.

In some embodiments, the helical structure includes a helical plate and the non-helical structure includes a flat plate.

In some embodiments, the helical plate includes a primary body including the first aperture and first and second legs extending away from the primary body, and the flat plate includes a primary body including the second aperture and first and second legs extending away from the primary body.

In some embodiments, the first leg of the helical plate and the flat plate are spaced apart axially a first distance, the second leg of the helical plate and the flat plate are spaced apart axially a second distance, and the second distance is greater than the first distance. The first distance may be the smallest gap between the helical plate and the flat plate and the second distance may be the largest gap between the helical plate and the flat plate. The first distance may be 2 to 3 mm and/or the second distance may be 5 to 6 mm.

In some embodiments, the first leg of the helical plate is axially aligned with the second leg of the flat plate, and the second leg of the helical plate is laterally offset from the flat plate relative to the longitudinal axis.

In some embodiments, the second leg of the helical plate and the first leg of the flat plate are each configured to be supplied with radio-frequency electric current, and the first leg of the helical plate and the second leg of the flat plate are configured to be connected to ground.

In some embodiments, the ICP torch further includes a spacer between the first leg of the helical plate and the second leg of the flat plate. The spacer may contact each of the first leg of the helical plate and the second leg of the flat plate.

In some embodiments, the ICP torch further includes an electrode connected to each of the second leg of the helical plate, the first leg of the flat plate, and the second leg of the flat plate.

In some embodiments, the ICP torch further includes a conductive plate to which the helical plate and flat plate are coupled. The electrodes and/or the conductive plate may be configured as a heat sink to promote cooling of the helical plate and flat plate.

In some embodiments, the primary body of the helical plate is in the shape of a loop and makes substantially a single rotation or turn between the first leg and the second leg of the helical plate.

In some embodiments, the helical plate and the flat plate each have a thickness of about 2 mm.

In some embodiments, the helical plate has a pitch of 4 to 6 mm per rotation.

In some embodiments, the helical structure includes a coil. The coil may be a single coil.

In some embodiments, the helical structure and/or the non-helical structure are formed of aluminum.

In some embodiments, the helical structure and/or the non-helical structure are formed of copper.

In some embodiments, the plurality of tubes include: an intermediate tube disposed about the injector, wherein the injector and the intermediate tube define an auxiliary gas passage configured to receive a flow of an auxiliary gas; and a plasma tube disposed about the intermediate tube, wherein the intermediate tube and the plasma tube define a plasma gas passage configured to receive a flow of a plasma gas.

In some embodiments, a maximum axial gap between a distal end of the intermediate tube and the helical plate is 4.9 to 5.1 mm.

In some embodiments, an axial gap between a distal end of the injector and a distal end of the intermediate tube is 2 to 3 mm.

Some other embodiments of the present technology are directed to an optical emission spectrometry (ICP-OES) system including an ICP torch as described herein.

Some other embodiments of the present technology are directed to a method for generating a plasma. The method includes providing an inductively coupled plasma (ICP) torch including: an injector tube including an injector flow passage to receive a flow of a sample fluid; an intermediate tube disposed about the injector tube, wherein the injector and the intermediate tube define an auxiliary gas passage configured to receive a flow of an auxiliary gas; a plasma tube disposed about the intermediate tube, wherein the intermediate tube and the plasma tube define a plasma gas passage configured to receive a flow of a plasma gas; and an induction device including a helical structure including a first aperture and a non-helical structure including a second aperture, wherein the first and second apertures define a passageway that is configured to receive the plasma tube. The method includes: flowing the auxiliary gas through the auxiliary gas passage; flowing the plasma gas through the plasma gas passage; and supplying a radio-frequency electric current to the induction device to inductively energize the auxiliary gas to produce a plasma proximate a distal end of the torch.

Further features, advantages and details of the present technology will be appreciated by those of ordinary skill in the art from a reading of the figures and the detailed description of the embodiments that follow, such description being merely illustrative of the present technology.

### BRIEF DESCRIPTION OF THE DRAWINGS

The accompanying drawings, which form a part of the specification, illustrate embodiments of the technology.

FIG. 1 is a schematic view of an ICP torch system according to some embodiments.

FIG. 2 is a perspective view of an induction device of the ICP torch system of FIG. 1 according to some embodiments.

FIG. 3 is another perspective view of the induction device of the ICP torch system of FIG. 1.

FIG. 4 is a fragmentary top view of the induction device of the ICP torch system of FIG. 1.

FIG. 5 is a front view of a helical plate of the induction device of FIGS. 2-4.

FIG. 6 is a side view of the helical plate of FIG. 5.

FIG. 7 is a front view of a flat plate of the induction device of FIGS. 2-4.

FIG. 8 is a side view of the helical plate of FIGS. 5 and 6 and the flat plate of FIG. 7.

FIG. 9 is a side view of an induction device of the ICP torch system of FIG. 1 according to some other embodiments.

FIG. 10 is an illustration of an optical emission spectroscopy system including an ICP torch system according to some embodiments.

### DETAILED DESCRIPTION

Many ICP-optical emission spectroscopy (OES) systems cannot handle “hard to run” samples. The systems do not generate plasma that is sufficiently “robust” to handle difficult matrices without extinguishing. One measure of robustness is how low power can be reduced while still maintaining a plasma. Another way to test robustness is to determine how much methanol can be run through the system while maintaining a plasma.

Some embodiments of the present technology are directed to an induction device for an ICP torch. The induction device may include one helical structure (e.g., helical plate) and one flat structure (e.g., flat plate) that are electrically connected to form an induction field that creates a more robust plasma.

Some known induction devices use coils. The problem generally with a coil-like arrangement is the temperature of the resulting plasma follows the coil. The present inventors determined that plates result in more even plasma, which is desirable.

The present inventors determined that various parameters, such as spacing between the plates as described herein and spacing between the plates and components of an ICP torch, are important to generate robust plasma.

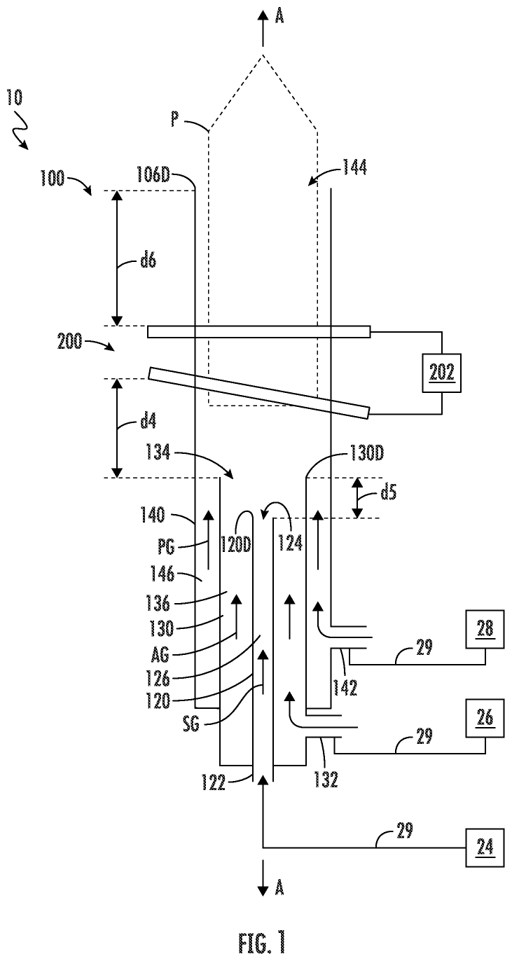

FIG. 1 is a schematic view of an ICP torch system 10 according to some embodiments. The ICP torch system 10 includes a torch 100, a sample source 24, an auxiliary gas source 26, and a plasma gas source 28. In use, a sample flow or stream SG (from the sample source 24), an auxiliary gas flow or stream AG (from the auxiliary gas source 26), and a plasma gas flow or stream PG (from the plasma gas source 28) are each forced or flowed through the torch 100 toward a distal end 106D of the torch 100. The ICP torch system 10 generates a plasma P at the distal end 106D from the auxiliary gas AG.

The plasma P may serve as an ionization source. In some embodiments, the plasma P decomposes a sample from the sample stream SG into its constituent elements and transforms those elements into ions. The sample may be an analyte of interest.

The sample source 24 may include a supply of a sample to be analyzed. The sample of interest may be provided in a solution or mixture. The sample source 24 may include an injector, nebulizer or other suitable device configured to deliver solid, liquid, or gaseous samples to the torch 100.

The auxiliary gas source 26 may include a supply of the auxiliary gas AG. The auxiliary gas AG may be any suitable gas from which the plasma P can be formed or generated as described herein. In some embodiments, the auxiliary gas AG is argon gas. In other embodiments, the auxiliary gas AG is nitrogen gas. The auxiliary gas source 26 is configured to provide a pressurized supply and flow of the auxiliary gas AG to the torch 100. The auxiliary gas source 26 may include a flow generator (e.g., a pump) and/or may contain a positively pressurized supply of the auxiliary gas AG.

The plasma gas source 28 may include a supply of the plasma gas PG. The plasma gas PG may be any suitable gas for serving the functions as described herein. In some embodiments, the plasma gas PG and the auxiliary gas AG have the same gas composition. In some embodiments, the plasma gas PG is argon gas. In other embodiments, the plasma gas PG is nitrogen gas. The plasma gas source 28 is configured to provide a pressurized supply and flow of the plasma gas PG to the torch 100. The plasma gas source 28 may include a flow generator (e.g., a pump) and/or may contain a positively pressurized supply of the plasma gas PG.

The torch 100 has a torch longitudinal axis A-A.

The ICP torch system 10 or the torch 100 includes an induction device or induction device assembly 200. In some embodiments, as described in more detail below, the induction device 200 may include a helical element or structure and a non-helical element or structure.

The torch 100 includes an injector 120, an intermediate tube 130, and a plasma tube 140. The intermediate tube 130 circumferentially surrounds the injector 120, and the plasma tube 140 circumferentially surrounds the intermediate tube 130. In some embodiments, the injector 120, the intermediate tube 130, and the plasma tube 140 are substantially concentric about the torch axis A-A.

The injector 120 may be formed of suitable material. In some embodiments, the injector tube 120 is formed of quartz, sapphire, or platinum.

The auxiliary tube 130 may be formed of suitable material. In some embodiments, the auxiliary tube 130 is formed of quartz.

The plasma tube 140 may be formed of suitable material. In some embodiments, the plasma tube 140 is formed of quartz.

The injector 120 has an inlet 122 and an outlet 124. The injector 120 includes a distal or terminal end 120D. The intermediate tube 130 has an inlet 132 and an outlet 134. The intermediate tube 130 includes a distal or terminal end 130D. The plasma tube 140 has an inlet 142 and an outlet 144. The plasma tube 140 has a distal or terminal end that corresponds to the distal end 106D of the torch 100.

The injector 120 defines an axially extending injector flow passage or sample passage 126 fluidly connecting the inlet 122 and the outlet 124. The injector 120 and the intermediate tube 130 define an axially extending auxiliary gas passage 136 between the opposing surfaces of the injector 120 and the intermediate tube 130. The auxiliary gas passage 136 fluidly connects the inlet 132 and the outlet 134. The intermediate tube 130 and the plasma tube 140 define an axially extending gas passage 146 between the opposing surfaces of the intermediate tube 130 and the plasma tube 140. The plasma gas passage 146 fluidly connects the inlet 142 and the outlet 144.

The sample source 24, the auxiliary gas source 26, and the plasma gas source 28 may be fluidly coupled to the inlet 122, the inlet 132, and the inlet 142, respectively, by corresponding conduits 29.

The induction device 200 may be electrically connected to a radio-frequency (RF) power supply 202. The RF power supply may be configured to provide RF energy or electric current into and through the induction device 200. The induction device will be described in more detail below.

In use, the sample gas SG is flowed through the sample gas passage 126, the auxiliary gas AG is flowed through the auxiliary gas passage 136, and the plasma gas PG is flowed through the plasma gas passage 146 toward the distal end 106D of the torch 100. It will be appreciated that the auxiliary gas stream AG is segregated from the sample gas stream SG by the injector tube 120 until the injector tube outlet 124, and is segregated from the plasma gas stream PG by the intermediate tube 130 until the outlet 134.

The induction device 200 is powered to inductively heat the auxiliary gas stream AG. An electric spark may be applied for a short time to introduce free electrons into the auxiliary gas stream AG. The auxiliary gas AG is thereby energized into a plasma P. The sample gas stream SG may enter the plasma P, where the sample gas stream evaporates and the molecules of the sample of interest break apart and the constituent atoms ionize.

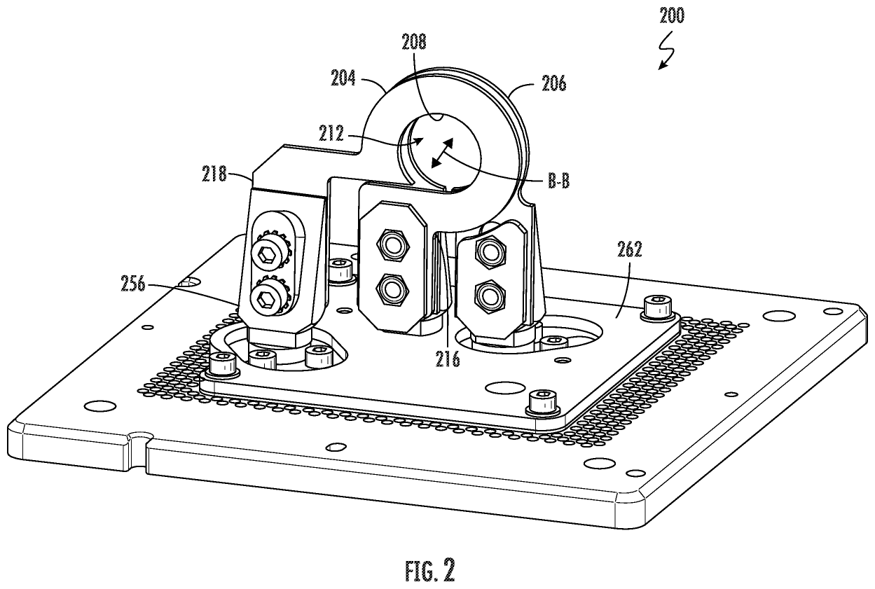

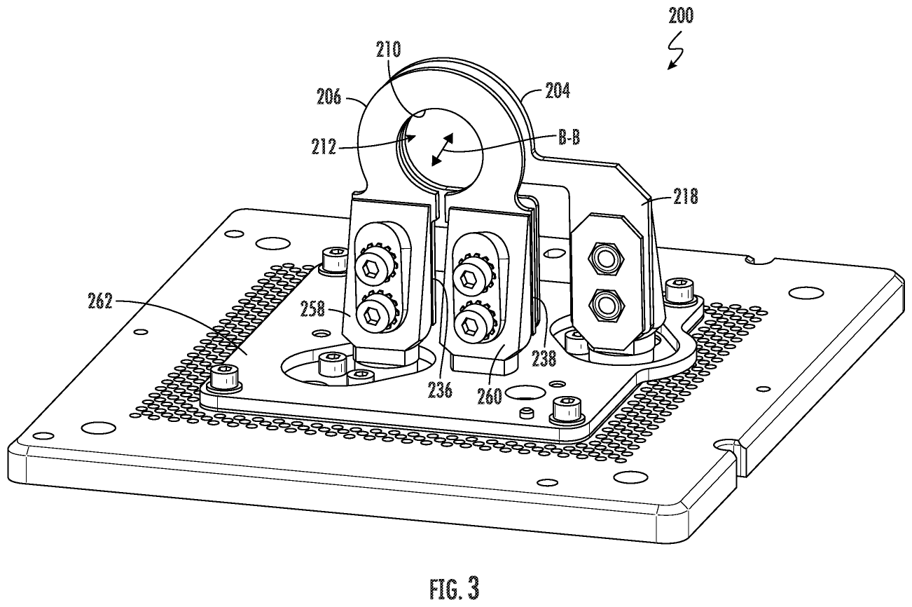

The induction device 200 is shown in more detail in FIGS. 2 and 3. The induction device 200 may include a helical structure such as a helical plate 204. The induction device 200 may include a flat structure such as a flat plate 206. The helical plate 204 includes a first aperture 208 and the flat plate 206 includes a second aperture 210. The first and second apertures 208, 210 define a passageway 212 configured to receive a portion of a body of an ICP torch, such as the plasma tube 140 of the torch 100 shown in FIG. 1. The passageway 212 defines a longitudinal axis B-B.

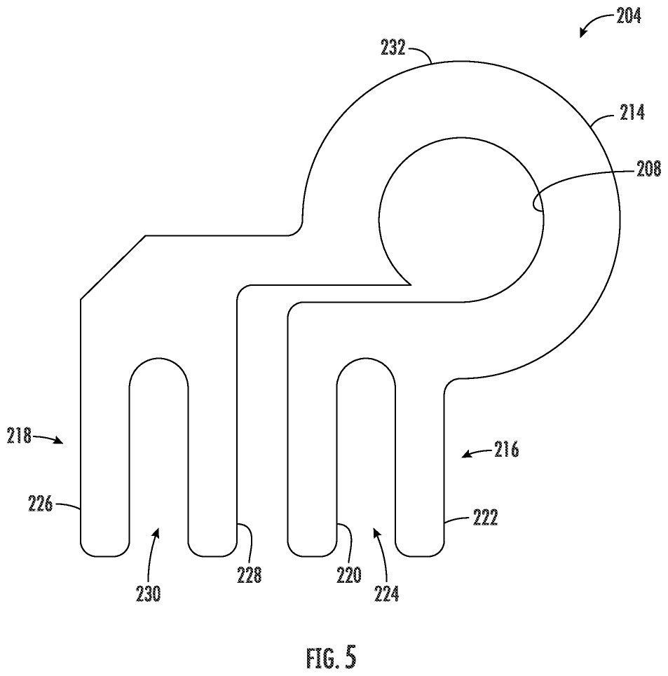

Referring to FIG. 5, the helical plate 204 may include a primary body 214 including the first aperture 208 and first and second spaced apart legs 216, 218 extending away from the primary body 214. The first leg 216 includes first and second prongs 220, 222 with a gap or slot 224 defined therebetween. Likewise, the second leg 218 includes first and second prongs 226, 228 with a gap or slot 230 defined therebetween. The first and second legs 216, 218 are configured for connection of the helical plate 204 to various components such as mounting structures and electrodes.

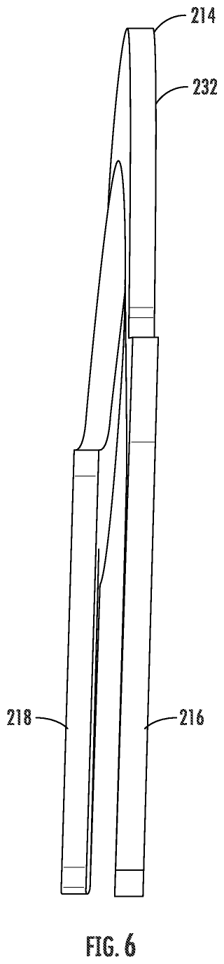

Referring to FIGS. 5 and 6, the primary body 214 defines a helical loop 232 that makes substantially one full rotation. As used herein, the term “substantially one full rotation” may mean within 50 degrees, within 35 degrees, and within 20 degrees of one full rotation in various embodiments.

The helical plate 204 (or the helical loop 232) may have a pitch of 3 mm to 7 mm per rotation and, in some embodiments, may have a pitch of 4 to 6 mm.

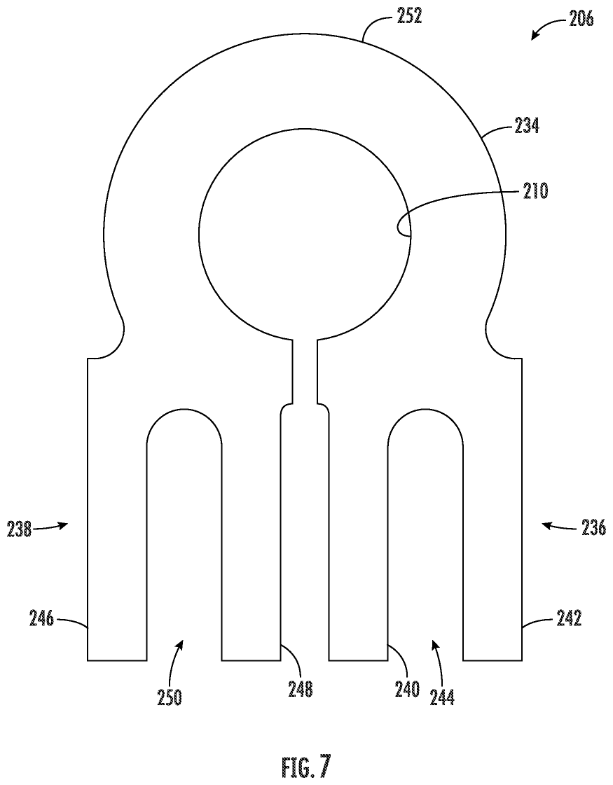

Referring to FIG. 7, the flat plate 206 may include a primary body 234 including the second aperture 210 and first and second spaced apart legs 236, 238 extending away from the primary body 234. The first leg 236 includes first and second prongs 240, 242 with a gap or slot 244 defined therebetween. Likewise, the second leg 238 includes first and second prongs 246, 248 with a gap or slot 250 defined therebetween. The first and second legs 236, 238 are configured for connection of the flat plate 206 to various components such as mounting structures and electrodes.

The primary body 234 defines a flat loop 252 that makes substantially one full rotation.

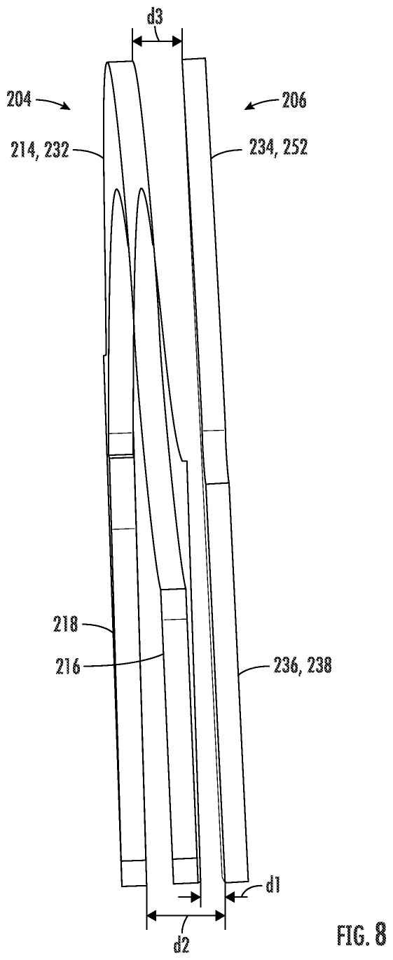

FIG. 8 illustrates the helical plate 204 and the flat plate 206 and the spacing therebetween. There may be a first axial spacing or axial gap d1 between the first leg 216 of the helical plate 204 and the flat plate 206. In various embodiments, the spacing d1 may be 0.5 mm to 5 mm, 1 mm to 4 mm, and 2 mm to 3 mm.

There may be a second axial spacing or axial gap d2 between the second leg 218 of the helical plate 204 and the flat plate 206. In various embodiments, the spacing d2 may be 2 mm to 8 mm, 3 mm to 7 mm, and 5 mm to 6 mm.

The present inventors have determined that best performance is attained when the gap d2=2.5±0.5 mm and the gap d3=5.5±0.5 mm.

There may be a third axial spacing or axial gap d3 between the “top” of the helical plate 204 and the “top” of the flat plate 206. In various embodiments, the spacing d3 may be 2 mm to 8 mm, 3 mm to 7 mm, and 5 mm to 6 mm. In some embodiments, the spacing d3 is less than the spacing d2.

Referring again to FIGS. 2 and 3, the first leg 216 of the helical plate 204 may be axially aligned with the second leg 238 of the flat plate 206. The second leg 218 of the helical plate 204 may be laterally offset from the flat plate 206 relative to the longitudinal axis B-B.

In some embodiments, the second leg 218 of the helical plate 204 and the first leg 236 of the flat plate 206 are each configured to be supplied with radio-frequency electric current. This may be from one or more sources RF sources such as the RF power supply 202 shown in FIG. 1. The first leg 216 of the helical plate 204 and the second leg 238 of the flat plate 206 may be configured to be connected to ground.

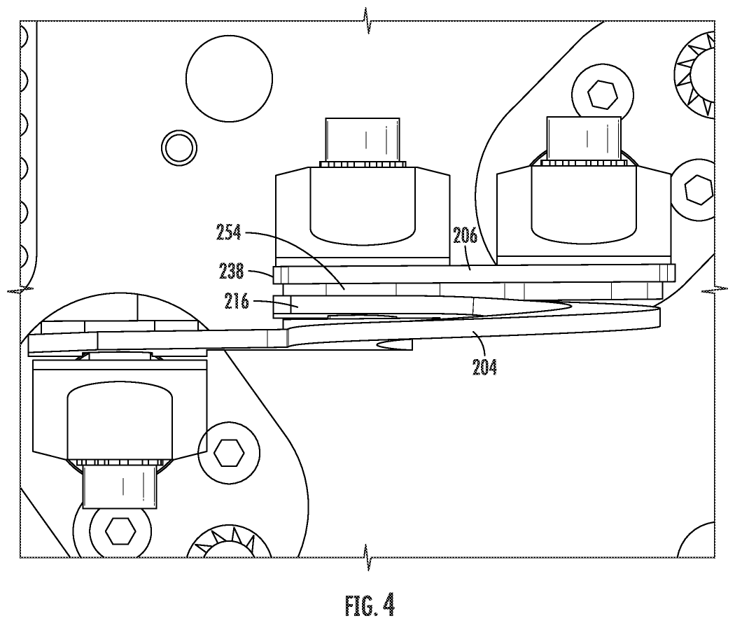

Referring to FIG. 4, a spacer 254 may be between the first leg 216 of the helical plate 204 and the second leg 238 of the flat plate 206. In some embodiments, the spacer 254 contacts each of the first leg 216 of the helical plate 204 and the second leg 238 of the flat plate 206. In some embodiments, the spacer has an axial length of 2 to 3 mm.

As shown in FIGS. 2 and 3, electrodes 256, 258, 260 may be connected to each of the second leg 218 of the helical plate 204, the first leg 236 of the flat plate 206, and/or the second leg 238 of the flat plate 206.

In some embodiments, the helical plate 204 and the flat plate 206 are coupled to a conductive plate 262. The electrodes 256, 258, 260 and the conductive plate 262 may be configured as a heat sink to promote cooling of the helical plate 204 and the flat plate 206. The electrodes 256, 258, 260 and the conductive plate 262 may be formed of any suitable material such as aluminum.

The conductive plate 262 may be coupled to an insulator plate 264. The insulator plate 264 may be coupled to a chassis of a device such as an ICP-OES device.

Referring again to FIG. 1, in various embodiments, a maximum axial gap or axial spacing d4 between the distal end 130D of the intermediate tube 130 and the helical plate 204 may be 0 mm to 10 mm, 2 mm to 8 mm, 4 mm to 6 mm, 4.5 mm to 5.5 mm, and 4.9 mm to 5.1 mm.

In various embodiments, a maximum axial gap or axial spacing d5 between the distal end 120D of the injector 120 and the distal end 130D of the intermediate tube 130 may be 0 mm to 5 mm, 1 mm to 4 mm, and 2 mm to 3 mm. In some embodiments, d4 is greater than d5.

The present inventors have determined that best performance is attained when the gap d4=5.0±0.1 mm and the gap d5=2.5±0.5 mm.

In various embodiments, an axial gap or axial spacing d6 between the distal end 106D of the torch 100 and the flat plate 206 may be 10 mm to 40 mm, 20 mm to 30 mm, 23 to 25 mm, or about 24 mm. A fixture having a length corresponding to the d6 spacing may be used to properly position the induction device 200 relative to the torch 100.

In some embodiments, the helical plate 204 and/or the flat plate 206 has a thickness of 1 mm to 3 mm and, in some embodiments, has a thickness of about 2 mm.

In some embodiments, the helical plate 204 and the flat plate 206 are formed of aluminum. This may allow for air-cooling of the plates (e.g., rather than water-cooling). In some other embodiments, the helical plate 204 and/or the flat plate 206 may be formed of copper.

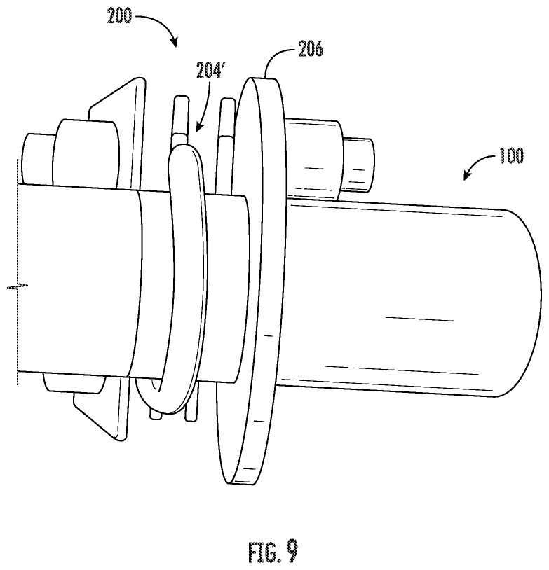

Referring to FIG. 9, in some other embodiments, the helical structure is a coil such as a single coil. Thus, the induction device 200 may include a helical coil 204′ and the flat plate 206. The torch 100 may be received through the coil 204′ and the flat plate 206. The coil 204′ may be formed of any suitable material such as aluminum or copper.

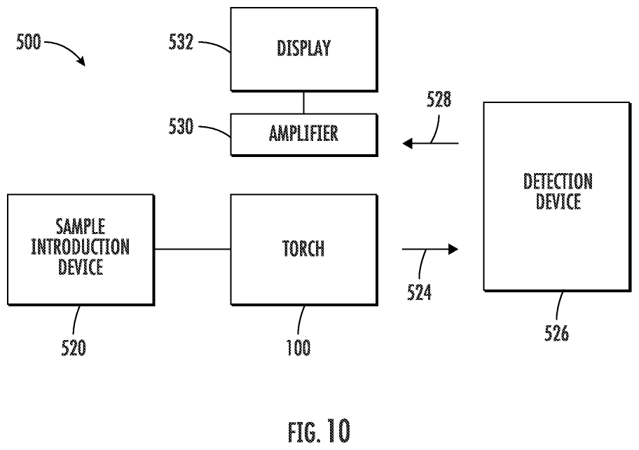

In certain configurations, an ICP torch including the induction device described herein can be used in optical emission spectroscopy (OES). Referring to FIG. 10, an ICP-OES device or system 500 includes a sample introduction device 520, an ICP torch 100 as described herein and including the induction device 200, and a detection device 526. The system 500 also includes (but not depicted in FIG. 10) an RF power supply 202, a sample supply 24, an auxiliary gas source 26, and a plasma gas source 28 operably connected to the torch 100.

The sample introduction device 520 may vary depending on the nature of the sample. In certain examples, the sample introduction device 520 may be a nebulizer that is configured to aerosolize liquid sample for introduction into the torch 100. In other examples, the sample introduction device 520 may be an injector configured to receive sample that may be directly injected or introduced into the torch 100. Other suitable devices and methods for introducing samples will be readily selected by the person of ordinary skill in the art, given the benefit of this disclosure.

The detector or detection device 526 may take numerous forms and may be any suitable device that may detect optical emissions, such as optical emission 524. For example, the detection device 526 may include suitable optics, such as lenses, mirrors, prisms, windows, band-pass filters, etc. The detection device 526 may also include gratings, such as echelle gratings, to provide a multi-channel OES device. Gratings such as echelle gratings may allow for simultaneous detection of multiple emission wavelengths. The gratings may be positioned within a monochromator or other suitable device for selection of one or more particular wavelengths to monitor. In certain examples, the detection device 526 may include a charge coupled device (CCD). In other examples, the OES device 500 may be configured to implement Fourier transforms to provide simultaneous detection of multiple emission wavelengths.

The detection device 526 may be configured to monitor emission wavelengths over a large wavelength range including, but not limited to, ultraviolet, visible, near and far infrared, etc. The OES device 500 may further include suitable electronics such as a microprocessor and/or computer and suitable circuitry to provide a desired signal and/or for data acquisition. Suitable additional devices and circuitry are known in the art and may be found, for example, on commercially available OES devices such as AVIO 200 series and AVIO 500 series OES devices commercially available from PerkinElmer Health Sciences, Inc. The optional amplifier 530, e.g., a photomultiplier tube, may be operative to increase a signal 528, e.g., amplify the signal from detected photons, and provides the signal to display 532, which may be a readout, computer, etc. In examples where the signal 528 is sufficiently large for display or detection, the amplifier 530 may be omitted. In certain examples, the amplifier 530 is a photomultiplier tube (PMT) configured to receive signals from the detection device 526. Other suitable devices for amplifying signals, however, will be selected by the person of ordinary skill in the art, given the benefit of this disclosure. If desired the PMT can be integrated into the detector 526.

In certain other configurations, an ICP torch including the induction device described herein can be used in an ICP-mass spectrometry (MS) device or system or an ICP-atomic absorption spectrometer (AAS) device or system.

The present technology has been described herein with reference to the accompanying drawings, in which illustrative embodiments of the technology are shown. In the drawings, the relative sizes of regions or features may be exaggerated for clarity. This technology may, however, be embodied in many different forms and should not be construed as limited to the embodiments set forth herein; rather, these embodiments are provided so that this disclosure will be thorough and complete, and will fully convey the scope of the technology to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present technology.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90° or at other orientations) and the spatially relative descriptors used herein interpreted accordingly.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. As used herein, the term “and/or” includes any and all combinations of one or more of the associated listed items. When the term “about” or “substantially equal to” is used in the specification the intended meaning is that the value is plus or minus 5% of the specified value.

It is noted that any one or more aspects or features described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present technology are explained in detail in the specification set forth herein.

Unless otherwise defined, all terms (including technical and scientific terms) used herein have the same meaning as commonly understood by one of ordinary skill in the art to which this technology belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The foregoing is illustrative of the present technology and is not to be construed as limiting thereof. Although a few example embodiments of this technology have been described, those skilled in the art will readily appreciate that many modifications are possible in the example embodiments without materially departing from the teachings and advantages of this technology. Accordingly, all such modifications are intended to be included within the scope of this technology as defined in the claims. The technology is defined by the following claims, with equivalents of the claims to be included therein.

1. An induction device comprising:
a helical structure comprising a first aperture; and
a non-helical structure comprising a second aperture,
wherein the first and second apertures define a passageway that is configured to receive a portion of a body of an inductively coupled plasma (ICP) torch, and wherein the passageway defines a longitudinal axis.

2. The induction device of claim 1 wherein the helical structure comprises a helical plate and the non-helical structure comprises a flat plate.

3. The induction device of claim 2 wherein the helical plate comprises a primary body including the first aperture and first and second legs extending away from the primary body, and wherein the flat plate comprises a primary body including the second aperture and first and second legs extending away from the primary body.

4. The induction device of claim 3 wherein the first leg of the helical plate and the flat plate are spaced apart axially a first distance, wherein the second leg of the helical plate and the flat plate are spaced apart axially a second distance, and wherein the second distance is greater than the first distance.

5. The induction device of claim 4 wherein the first distance is the smallest gap between the helical plate and the flat plate and the second distance is the largest gap between the helical plate and the flat plate.

6. The induction device of claim 4 wherein the first distance is 2 to 3 mm and the second distance is 5 to 6 mm.

7. The induction device of claim 3 wherein the first leg of the helical plate is axially aligned with the second leg of the flat plate, and wherein the second leg of the helical plate is laterally offset from the flat plate relative to the longitudinal axis.

8. The induction device of claim 7 wherein the second leg of the helical plate and the first leg of the flat plate are each configured to be supplied with radio-frequency electric current, and wherein the first leg of the helical plate and the second leg of the flat plate are configured to be connected to ground.

9. The induction device of claim 7 further comprising a spacer between the first leg of the helical plate and the second leg of the flat plate, wherein the spacer contacts each of the first leg of the helical plate and the second leg of the flat plate.

10. (canceled)

11. The induction device of claim 7 further comprising an electrode connected to each of the second leg of the helical plate, the first leg of the flat plate, and the second leg of the flat plate.

12. The induction device of claim 11 further comprising a conductive plate to which the helical plate and flat plate are coupled, wherein the electrodes and the conductive plate are configured as a heat sink to promote cooling of the helical plate and flat plate.

13. The induction device of claim 3 wherein the primary body of the helical plate is in the shape of a loop and makes substantially a single rotation or turn between the first leg and the second leg of the helical plate.

14. The induction device of claim 2 wherein the helical plate and the flat plate each have a thickness of about 2 mm.

15. The induction device of claim 2 wherein the helical plate has a pitch of 4 to 6 mm per rotation.

16. The induction device of claim 1 wherein the helical structure comprises a coil.

17. (canceled)

18. The induction device of claim 1 wherein the helical structure and/or the non-helical structure are formed of aluminum.

19. (canceled)

20. An inductively coupled plasma (ICP) torch comprising:
an injector configured to receive a flow of a sample fluid;
a plurality of tubes disposed about the injector and configured to receive and direct a flow of one or more torch gases; and
an induction device disposed about at least one of the plurality of tubes, the induction device configured to receive a radio-frequency electric current to inductively energize at least one of the one or more torch gases to produce a plasma proximate a distal end of the ICP torch,
wherein the induction device comprises:
a helical structure comprising a first aperture; and
a non-helical structure comprising a second aperture,
wherein the first and second apertures define a passageway that is configured to receive the at least one of the plurality of tubes, and wherein the passageway defines a longitudinal axis.

21-38. (canceled)

39. The ICP torch of claim 21 wherein the plurality of tubes comprise:
an intermediate tube disposed about the injector, wherein the injector and the intermediate tube define an auxiliary gas passage configured to receive a flow of an auxiliary gas; and
a plasma tube disposed about the intermediate tube, wherein the intermediate tube and the plasma tube define a plasma gas passage configured to receive a flow of a plasma gas.

40. The ICP torch of claim 39, wherein a maximum axial gap between a distal end of the intermediate tube and the helical plate is 4.9 to 5.1 mm.

41. The ICP torch of claim 39 wherein an axial gap between a distal end of the injector and a distal end of the intermediate tube is 2 to 3 mm.

42. (canceled)

43. (canceled)
